(19) United States
(12) Patent Application Publication
(10) Pub. No.: US 2012/0086561 A1
(43) Pub. Date: Apr. 12, 2012

(54) OUTDOOR LIGHTING SYSTEM

(75) Inventors: Laszlo Sandor Ilyes, Richmond Heights, OH (US); Jason D. Creighton, Streetsboro, OH (US)

(73) Assignee: General Electric Company

(21) Appl. No.: 12/899,972

(22) Filed: Oct. 7, 2010

(51) Int. Cl. G05B 11/01; H05B 37/02

(52) U.S. Cl. 340/12.32; 315/312

(57) ABSTRACT

An outdoor lighting system and operating methods are presented in which Power-Line-Communication (PLC)-enabled outdoor lighting fixtures form an outdoor lighting network and a lighting control system obtains data from PLC-enabled utility meters by communications through a general purpose network and the outdoor lighting network.

### BACKGROUND OF THE DISCLOSURE

Outdoor lighting systems provide lighting for roadways, parking lots, building exteriors, and other outdoor areas using fixtures mounted on poles or other structures. The lighting fixtures are wired to a source of AC line power and include drivers or ballasts providing power to lamps, LEDs or other light sources. In addition, many outdoor lighting fixtures have a photo eye (PE) sensor or detector to detect sunrise and sunset conditions for turning the light off or on, respectively. Improved energy efficiency is desired for outdoor lighting systems, and hence improved lighting fixtures and accessories are desired to provide communications capabilities by which outdoor lighting fixtures can be intelligently used to provide lighting without consuming excessive energy.

### CROSS REFERENCE TO RELATED APPLICATIONS

Reference is made to co-pending U.S. patent application Ser. No. ______, filed on ______ (attorney docket number 244187/GECZ201100), the entirety of which is hereby incorporated by reference as if full set forth herein.

### SUMMARY OF THE DISCLOSURE

The present disclosure provides outdoor lighting systems and methods in which PLC-enabled outdoor lighting fixtures form one or more outdoor lighting networks for control and/or monitoring by a lighting control system and the control system obtains data from PLC-enabled utility meters by communications through a general purpose network and the lighting system network.

An outdoor lighting system is provided that includes a Power-Line-Communication (PLC)-enabled outdoor lighting fixture operative to communicate by power line signaling with a PLC-enabled utility meter via a PLC outdoor lighting network. A bridging component in the system provides communications interfacing between the PLC outdoor lighting network and a general purpose network, and a lighting control system controls or monitors one or more PLC-enabled outdoor lighting fixtures and obtains meter data from the utility meter by communications through the general purpose network, the bridging component, and the PLC outdoor lighting network.

In certain embodiments, the bridging component is a powerline bridge and router which provides communications interfacing between the PLC outdoor lighting network and the general purpose network. In certain embodiments, the bridging component provides an Internet connection to the lighting fixture to interface communications between the lighting network and the general purpose network. In certain embodiments, the bridging component is a modem coupled with the outdoor lighting fixture to interface the communications between the lighting network and the general purpose network.

In certain embodiments, the fixtures establish PLC network connections to form first and second PLC outdoor lighting networks and a repeater provides communications interfacing between the first and second PLC outdoor lighting networks.

In certain embodiments, one or more occupancy or motion sensors are operatively coupled with the PLC-enabled outdoor lighting fixtures, and the fixtures notify one another of a sensed occupancy or motion signal or message received from the occupancy or motion sensor(s) via the PLC outdoor lighting network.

In certain embodiments, the PLC outdoor lighting network includes an RF communications connection between at least two of the outdoor lighting fixtures.

A method is presented for operating an outdoor lighting system, which includes establishing PLC network connections between PLC-enabled outdoor lighting fixtures to form a PLC outdoor lighting network, as well as providing communications interfacing between the PLC outdoor lighting network and a general purpose network and controlling or monitoring at least one of the PLC-enabled outdoor lighting fixtures via communications through the general purpose network and the PLC outdoor lighting network. The method also includes establishing at least one auxiliary communications connection between one or more of the lighting fixtures and at least one PLC-enabled utility meter, and obtaining data from the meter by communications through the general purpose network and the PLC outdoor lighting network.

In certain embodiments, the method also includes establishing RF connections between at least some of a plurality of the PLC-enabled outdoor lighting fixtures of the PLC outdoor lighting network.

Certain embodiments of the method further include operatively coupling one or more occupancy or motion sensors with one of the outdoor lighting fixtures, as well as notifying another one of the PLC-enabled outdoor lighting fixtures of a sensed occupancy or motion signal or message via the PLC outdoor lighting network.

An outdoor lighting fixture apparatus is disclosed, which includes a fixture assembly having a fixture housing, a light source, and a ballast or driver to provide power to the light source. The fixture apparatus further includes a controller module with a PLC transceiver that provides powerline communications using a first communications protocol with at least one other outdoor lighting fixture apparatus in a PLC outdoor lighting network, where the PLC transceiver provides powerline communications using a second communications protocol with at least one PLC-enabled utility meter.

In certain embodiments, the controller module includes an RF transceiver operative to provide RF communications with another outdoor lighting fixtures of the PLC outdoor lighting network.

Certain embodiments of the outdoor lighting fixture apparatus includes at least one occupancy or motion sensor operatively coupled with the controller module.

In certain embodiments, the controller module notifies another outdoor lighting fixture apparatus of a sensed occupancy or motion signal or message received from the occupancy or motion sensor via the outdoor lighting network.

### BRIEF DESCRIPTION OF THE DRAWINGS

One or more exemplary embodiments are set forth in the following detailed description and the drawings, in which:

FIG. 1 is a system diagram illustrating an exemplary outdoor lighting system including RF-enabled outdoor fixtures forming a mesh network bridged with a lighting control system of a general purpose network system, where the control system obtains data from RF-enabled utility meters by communications through a general purpose network and the lighting system RF network.

FIG. 2 is a partial sectional side elevation vie illustrating an exemplary dimmable outdoor lighting fixture apparatus with a controller module having an RF transceiver operative to provide RF communications to other lighting fixtures using a first communications protocol and to communicate with RF-enabled utility meters using a second protocol;

FIG. 3 is a schematic diagram illustrating further details of the controller module in the outdoor lighting fixture apparatus of FIG. 2;

FIG. 4 is another system diagram showing an exemplary outdoor lighting system with multiple a mesh network portions interconnected by a repeater with one portion bridged to a general purpose network system;

FIGS. 5A and 5B are partial system drawings illustrating use of motion/occupancy sensor(s) with reporting of sensed conditions between outdoor lighting fixtures via a lighting system network for intelligent lighting control; and

FIG. 6 is a system diagram illustrating an exemplary outdoor lighting system including Power Line Carrier (PLC)-enabled outdoor lighting fixtures forming a Lighting system network that is bridged with a lighting control system of a general purpose network system, where the control system obtains data from RF-enabled utility meters by communications through a general purpose network and the lighting system network.

### DETAILED DESCRIPTION

Referring now to the drawings, like reference numerals are used in the figures to refer to like elements throughout, and the various features are not necessarily drawn to scale. The present disclosure relates to outdoor lighting systems and methods in which RF and/or PLC-enabled outdoor lighting fixtures form one or more networks for control and/or monitoring by a lighting control system of a general purpose network, with the control system able to obtain data from one or more utility meters by communications through general purpose network and the lighting system network. The disclosed embodiments may be advantageously employed to facilitate utility meter reading without requiring manual reading of residential or commercial/industrial meters or localized wireless readings obtained from vehicles traversing local streets. Instead, utilities and other meter data consumers can obtain meter information via lighting control systems that control and/or monitor outdoor lighting fixtures via RF mesh networks and/or PLC-based local networks, with the lighting control system obtaining the meter data by communications through the general purpose network and the lighting system network. This usage of the outdoor lighting infrastructure as a conduit for utility meter information may thus save vast resources of utility companies in staffing manual meter reading operations and/or the expense of constructing and maintaining dedicated network infrastructures.

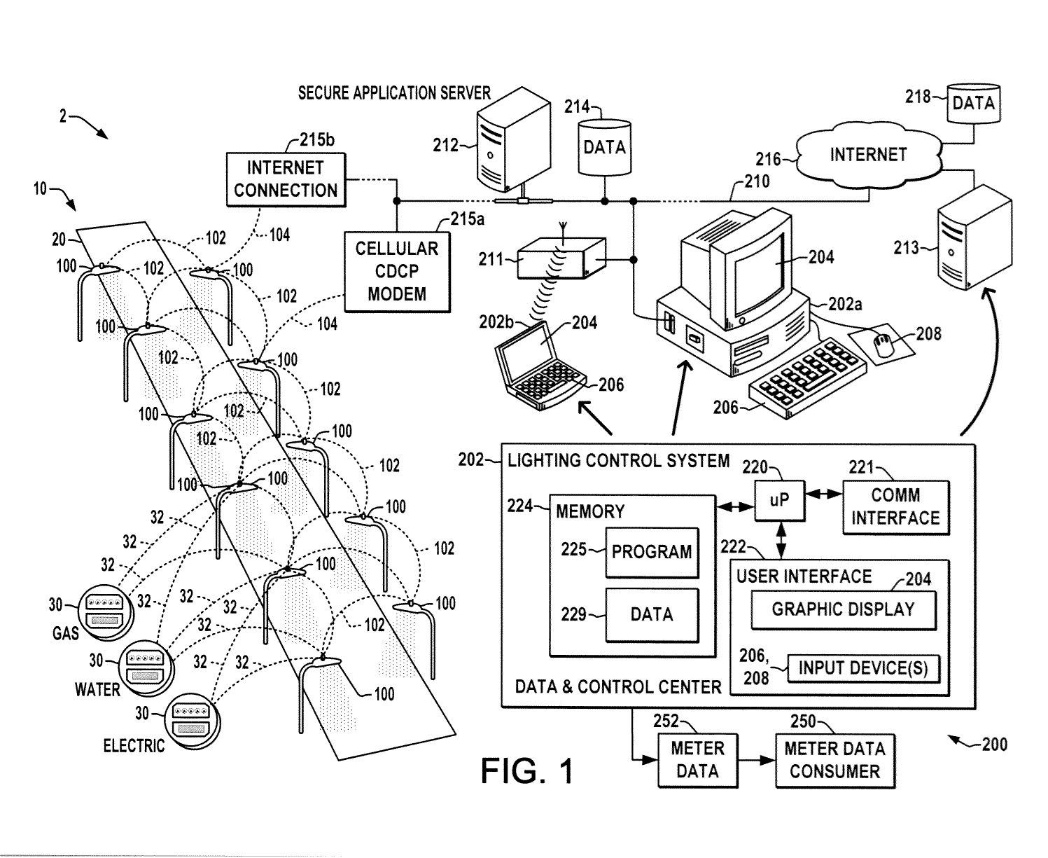

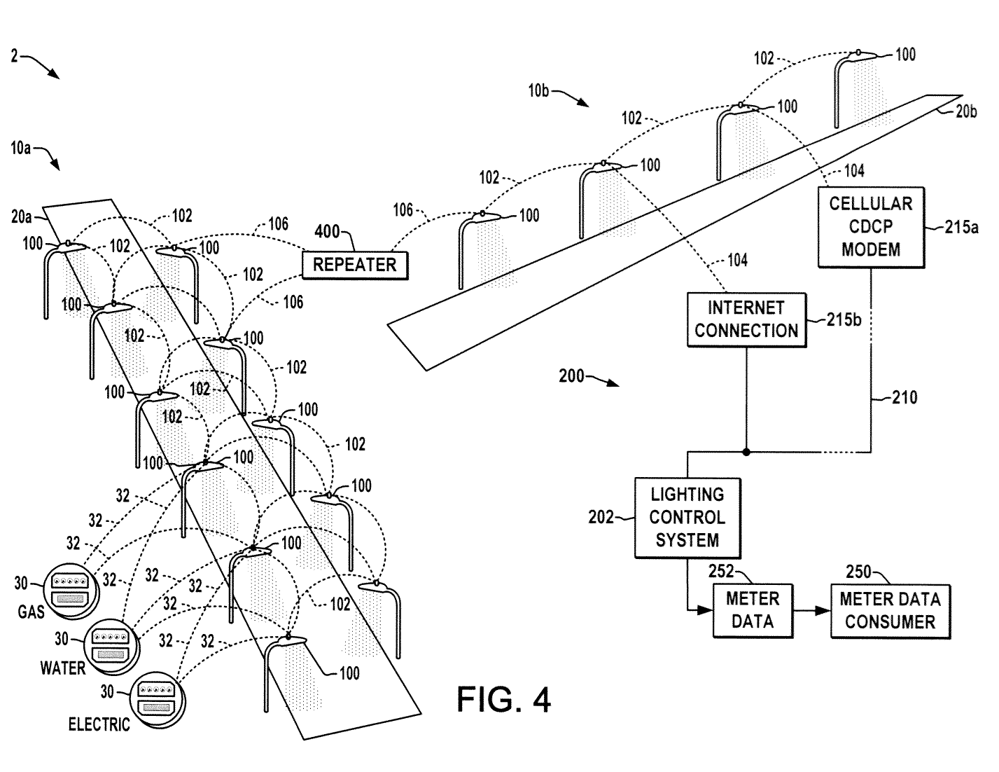

Referring initially to FIGS. 1-4, FIG. 1 depicts an exemplary outdoor lighting system 2 with RF-enabled outdoor lighting fixtures 100 forming an RF mesh network 10 for communication between some or all fixtures 100 proximate a roadway or street 20, where the mesh network 10 is formed via one or more individual RF communications connections or links 102 between fixtures 100 that are within range of one another. The links 102 may be continuous or discontinuous, with the network 10 being an ad-hoc self-healing network. The fixtures 100 in certain embodiments are individually addressable, such that each is capable of identifying a message and relaying received messages to other fixtures within the network 10, whereby two fixtures 100 can communication with one another through one or more intervening fixtures 100, even though they are not directly within RF range of each other. As shown in FIG. 4, moreover, the RE-enabled outdoor lighting fixtures 100 may establish RF mesh network connections 102 to form multiple mesh network portions with repeaters 400 bridging the portions. For example, FIG. 4 shows a first RF mesh network 10a and a second RF mesh network 10b, with a repeater 400 providing communications interfacing between the networks 10a, 10b. Moreover, one or more of the RF-enabled outdoor lighting fixtures 100 is operative to communicate by RF signaling with at least one RF-enabled utility meter 30, such as RF-enabled gas meters 30, water meters 30, electric power meters 30, for example.

The RF mesh network 10 is bridged with a lighting control system 202 of a general purpose network system 200 using any suitable bridging apparatus. In the examples of FIGS. 1-4, a bridging component 215 provides communications interfacing between the RF mesh network 10 and a general purpose network 210 of a network system 200. In certain embodiments, the bridging component is a modem, such as a pole-mounted Central Data Collection Point (CDCP) modem 215a operatively coupled to one of the fixtures 100 of the RF mesh network 10 to provide communications interfacing between the RF mesh network 10 and the general purpose network 210. In other embodiments, a pole-mounted Internet connection bridging component 215b provides an Internet connection to one of the RF-enabled outdoor lighting fixtures 100 of the RF mesh network 10 and interfaces communications between the networks 10 and 210.

The control system 202 is operative to obtain meter data 252 from one or more RF-enabled utility meters 30 by communications through the general purpose network 210 and the lighting system RF network 10. The control system 202 can then provide the meter data 252 to one or more meter data consumers 250, such as utility companies, municipalities, companies, etc. In operation, the lighting control system 202 is operatively coupled with the general purpose network 210 by any suitable network interconnections, direct and/or indirect, including wired and/or wireless interconnections for transferring signaling and/or messaging. The system 202 further operates to control or monitor at least one of the RF-enabled outdoor lighting fixtures 100, in addition to obtaining data from the RF-enabled utility meter(s) 30 via communications through the general purpose network 210, the bridging component 215, and the RF mesh network 10.

In certain embodiments, the RF mesh network 10 uses a ZigBee wireless protocol, although other suitable communications protocols can be used. Moreover, the fixtures 100 may be operative according to different protocols, for example, using a first protocol (e.g., ZigBee) to communicate with other fixtures in the mesh network 10, and may also employ a second protocol to communicate with utility meters 30. In certain embodiments, the lighting control system 202 can instruct one or more of the lighting fixtures 100 to switch to a second protocol for contacting one or more meters 30 to obtain readings or other data therefrom, after which the fixture 100 will revert to the first protocol to relay the obtained meter data 252 back to the controller 202 via the RF mesh network 10, any intervening router(s) 400, the bridging component 215, and the general purpose network 210.

The wireless interface of the individual fixtures 100 may act as a router and retransmit received messages that are not destined for that particular fixture 100, thereby facilitating establishment and operation of the mesh network 10. Additionally, if a message is destined for the ballast control unit, the message is relayed to the control module and the command therein is used to control the dimmable ballasts and/or the light outputs. Other devices may be coupled with the mesh network 10 beyond the illustrated outdoor lighting fixtures 100, meters 30, repeaters 400, and bridging components 215, for example, external RF-enabled occupancy/motion sensors 140, external RF transmitters and/or receivers 130, and other like devices. For example, the mesh network 10 in certain embodiments may include a coordinator unit, such as a single coordinator per mesh network 10 (e.g., 1 for network portion 10a and another for portion 10b in FIG. 4). Upon initiating any network device, the fixture 100 registers with the coordinator unit using a unique id. In the case of the outdoor fixtures 100, registration may include messages notifying the coordinator unit of the capabilities of the fixture, for example, how many dimmable driver/ballasts 116 and light sources 114 and other fixture parameters, such as current dimming programs, profiles, or their control parameters, and/or diagnostic information.

The coordinator may coordinate the fixtures 100 with any other network devices and with one another. For example, the coordinator may send messages to the fixture 100 containing commands operative to control dimmable ballasts 116 and the light outputs thereof. The coordinator unit may act based upon internal stimuli, such as an internal clock or timer, or external stimuli, such as an event triggered by a network device or a user, or instance, based on commands received from the lighting control system 202. For example, a coordinator unit may instruct the fixture 100 to power on light outputs at a certain time or to power on light outputs in response to motion sensed by a motion sensor device 140. The coordinator may be a dedicated network device or can be integrated with another network device having additional functions. For example, alight fixture 100 or a bridging device 215, or a motion sensor 140 may act as the coordinator unit in addition to its above described functionality. Additionally, not every network device within the mesh network 10 need necessarily act as a router.

As shown in FIG. 1, the general purpose network system 200 can be any single or multiple network architecture providing a processing environment in which one or more aspects of the present disclosure may be practiced. The system 200 includes one or more processor-based lighting control systems 202 that may be implemented in a networked computing environment. In the example of FIG. 1, a desktop computer 202a and a portable computer 202b are operatively coupled with a network 210, each of which includes a graphical display 204 and one or more input devices, such as a keyboard 206, a mouse or other pointing device 208, microphones for speech commands, or other user input devices (not shown), where the portable computer 202b is coupled with the network 210 via a wireless transceiver 211. The network 210, in turn, may be operatively connected with other networks, such as interne 216 providing operative access between the computers 202 and one or more of a network server 212, a network database 214, and/or an interne data store 218 and a further server 213. In this regard, one or both of the data stores 214, 218, and/or the servers 212, 213 or the computers 202 may store meter data 252 desired by a meter data consumer 250 to provide a unitary or distributed secure database, where such storage may also be used for lighting control data or other information related to outdoor lighting systems being operated and monitored by the lighting control system 202.

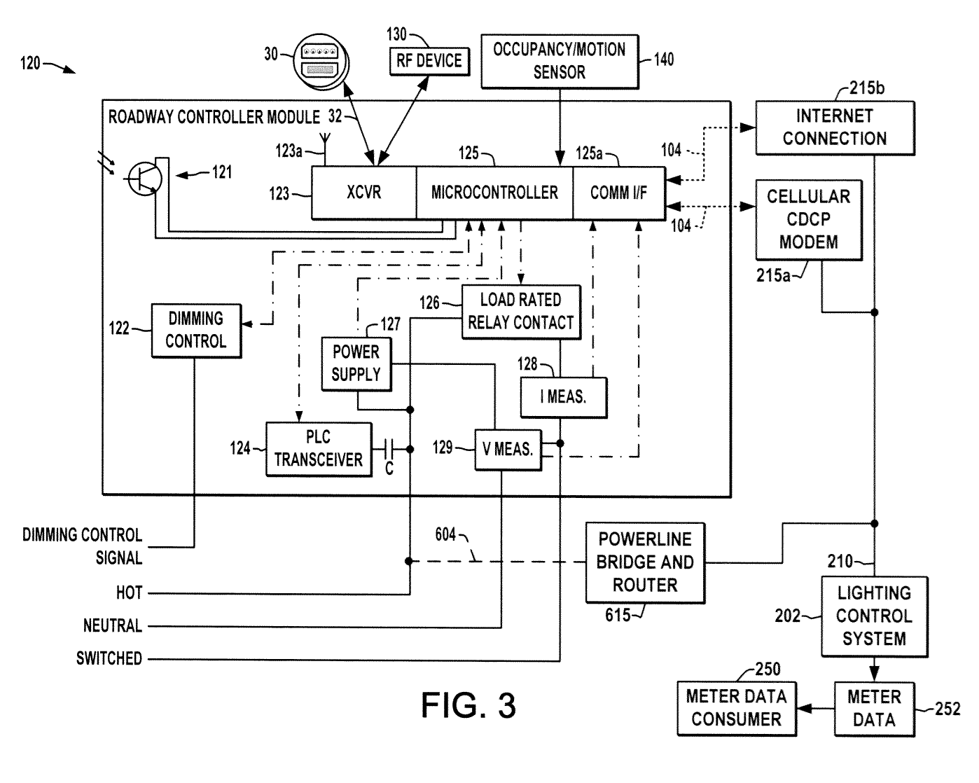

The presently disclosed systems and methods may be implemented in certain embodiments using one or more software program components operating or otherwise executed by a microprocessor or other processing element (e.g. microprocessor 220 in the processor-based system 202, microcontroller 125 in the lighting fixture control modules 120 as shown in FIG. 3, etc.). As best shown in FIG. 1, the processor-based lighting control system 202 can be implemented in whole or in part in a network server 212, in one or both of the computers 202, and/or in combination thereof. The control system 202 includes a microprocessor or other processing element 220, a communication interface 221 that operatively interconnects the processor-based system 202 with the network 210, as well as a memory 224 and a graphical user interface 222 providing a graphic display 204 and one or more input devices such as the illustrated computer keyboard and/or mouse 206, 208. The memory 224 in this example includes data 229 and computer readable program code 225 with instructions executable by the processor 220 to implement the functionality described herein, where the system 202 may operate on a unitary data set, and/or the data may be implemented in distributed storage fashion with storage of portions in the processor-based system 202, the network server 212, and/or in one or more internet based data stores 213, 214, 218.

The system 202 is operatively interconnected (e.g., via the network 210) with one or more bridging components 215, such as a wireless network via a Cellular CDPD modem or other wireless interface 215a or an internet connection 215b providing data exchange and other communication by and between one or more devices of the mesh network system 10 such as the light fixtures 100, and/or the meters 30 such that the processor-based lighting control system 202 receives data from and/or provides data to the devices 140, 100, 30. The processing element 220 in these embodiments executes the program to implement a data and control center system to allow gathering of meter data 252 from one or more of the meters 30 that are communicatively coupled (continuously or intermittently) with the mesh network 10, where a given meter 30 can be read using an RF connection between it and at least one of the RF-enabled lighting fixtures 100 of the mesh network 10 as shown in FIG. 1 and/or using a powerline connection 604 (PLC-based) with one or more PLC-enabled fixtures 100 of an outdoor lighting network.

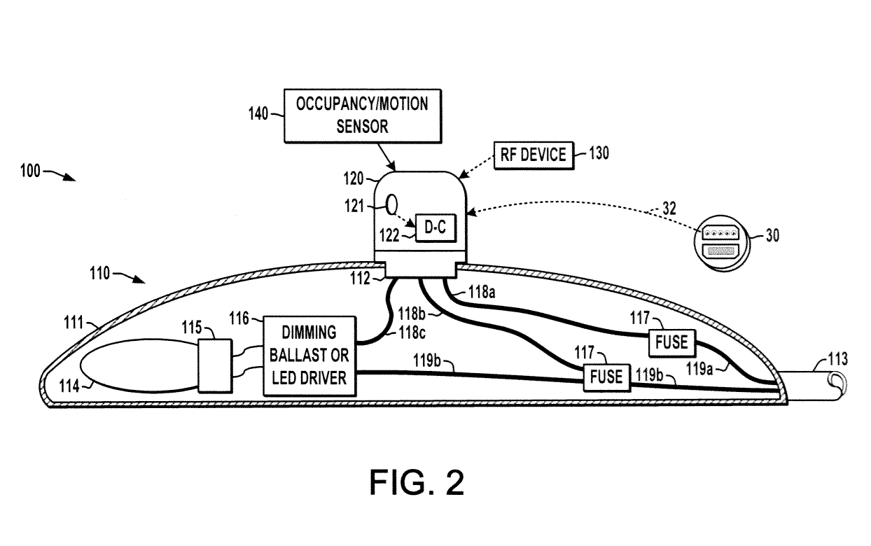

FIGS. 2 and 3 show further details of an exemplary outdoor lighting fixture apparatus 100 including a horizontal luminaire fixture assembly 110 with a fixture housing structure 111 having an inlet conduit 113 for receiving power wiring, where the fixture housing 111 may be mounted to a building or to a pole or other support structure for a particular outdoor lighting application. One or more light sources 114 are supported in the fixture housing 111 via sockets 115, such as incandescent lamps, fluorescent lamps, high intensity discharge (HID) lamps, LEDs or arrays thereof, etc. The light source(s) 114 is driven by a ballast or driver 116, also supported in the housing 111. In certain embodiments a twist-lock receptacle 112 is mounted to the top of the fixture housing 111 for connection of a controller module 120. The controller module 120 may include a photo sensor 121 operative to sense ambient light near the fixture assembly 110 for controlling turn on and turn off timing in certain embodiments. The twist-lock connector and the receptacle 112 provide electrical connection via wires 118a, 118b, and 118c, with two input wires 119a and 119b routed into the housing 111 via the conduit 113, which may optionally be terminated at fuses 117. In one example, a first phase (line) wire 118a connects the power line from the first fuse 117 to a first receptacle terminal and a second phase wire 118b connects the power neutral to the second terminal, with the neutral also being connected from the second fuse 117 to the driver or ballast 116 via wire 119b. The power line is selectively switched by the controller module 120 and provided to the ballast or driver 116 via a switched line wire 118c, such that the ballast or driver 116 is selectively powered or unpowered by the operation of the controller 120 which may include a load rated relay contact 126 (FIG. 3) operative according to a switch control signal from the microcontroller 125 of the controller module 120 to selectively couple the incoming line connection 118a with the switched power line 118c. A dimming control signal may be introduced in certain embodiments from a dimming control/command component 122 to within the fixture housing 111 (FIG. 2) through a modification of the twist-lock socket 112, such as by including a fourth and/or a fifth conductor to convey this signal to the dimming ballast or driver 116 within the housing 111.

As shown in FIG. 3, the controller module 120 includes a dimming component (dimming command component) 122, which can be any suitable circuitry, hardware, processor-executed software or firmware, logic, etc., which operates to selectively provide one or more dimming control values or signals to the ballast or driver 116 through the twist-lock receptacle 112 so as to cause the ballast or driver 116 to provide dimmable output from the light source(s) 114. The dimming component 122 is operatively coupled to the microcontroller 125 that includes a transceiver 123 with an antenna 123a for RF communications according to one or more protocols with other RF devices 130 (e.g., external RF control devices), other RF-enabled fixtures 100, and/or with one or more RF-enabled utility meters 30. The microcontroller 125 also includes a communications interface 125a providing communications interfacing with an Internet connection bridging component 215b and/or with a CDPD modem bridging device 215a for ultimate connection with the lighting control system 202. In addition, the module 120 may include a Power Line Communication (PLC) transceiver 124 and a coupling capacitance C allowing the microcontroller 125 to communicate with other fixtures 100, meters 30, and/or a powerline bridge and router 615 via signaling connections 604 on one or both of the line power connections. Moreover, the module 120 may also include current and/or voltage measurement or sensing circuitry or components 128 and 129 for sensing input or switched power conditions for intelligent (e.g., feedback-type) dimming control.

The control module 120 in certain embodiments also includes a photo sensor 121 which senses ambient light proximate the fixture assembly 110 and provides a sensed light signal or value to the dimming component 122. The dimming component 172 selectively provides the dimming control value or values (e.g., 0-10V signal, messages, etc.) to the ballast or driver 116 in certain embodiments based at least in part on the sensed light signal or value. For example, the dimming component 122 may be programmed or otherwise configured to provide dimmed light via the dimming control value selection at dawn and/or dusk for reduced power consumption and for esthetic lighting, rather than the conventional full on/full off operation. In certain embodiments, moreover, the dimming component 122 may be operative to selectively dim the light output during certain times for energy conservation, for instance, to dim unused roadways to a safe but efficient level in the middle of the night, with possible dimming control modification/override according to signals or values received from an occupancy/motion sensor 140 operatively coupled with the microcontroller 125. In certain embodiments, moreover, the dimming control component 122 may be implemented as one or more software components executed by the microcontroller 125.

In certain embodiments, the dimming component 122 is operative to selectively provide the dimming control value based at least in part on a received RF signal or value from an external RF device 130. For instance, an RF command signal can be sent to the controller module 120 wirelessly (and such signal can be sent to multiple controllers 120) for initiating dimmed, full on, full off, flashing operation, or combinations thereof by a control device 130 having an RF transmitter, thus allowing security personnel to control outdoor lighting operation. The dimming component 122 may thus provide the dimming control value(s) to control the light output according to one or more criteria, some of which may be externally actuated (e.g., via the PE sensor 12), motion sensor 140, and/or RF device 130 or combinations thereof) and some of which may be preprogrammed in the controller module 120.

Referring to FIGS. 2-5B, the system 2 may also include one or more occupancy/motion sensors 140 operatively coupled with one of the RF-enabled outdoor lighting fixtures 100 or otherwise coupled with the network 10. For instance, the controller module 120 may be operatively coupled with a motion sensor 140 (FIG. 2) to receive a wired or wireless signal (e.g., via transceiver and antennal 123, 123a) therefrom indicating detected or sensed motion or person/vehicle occupancy near and/or lit by the fixture 110, and the dimming component 122 is operative to selectively provide the dimming control value based at least in part on a sensed motion light signal or value from the motion sensor 140. For example, the dimming component 122 may increase a dimmed power level (or go to full-on operation from a previously dimmed setting) when motion is sensed and continue this modified operation for a predetermined time or until a separate reset command is received at the controller 120. In other embodiments, the dimming control signal can be varied for output light flashing operation based at least in part on a received motion detection signal from the sensor 140.

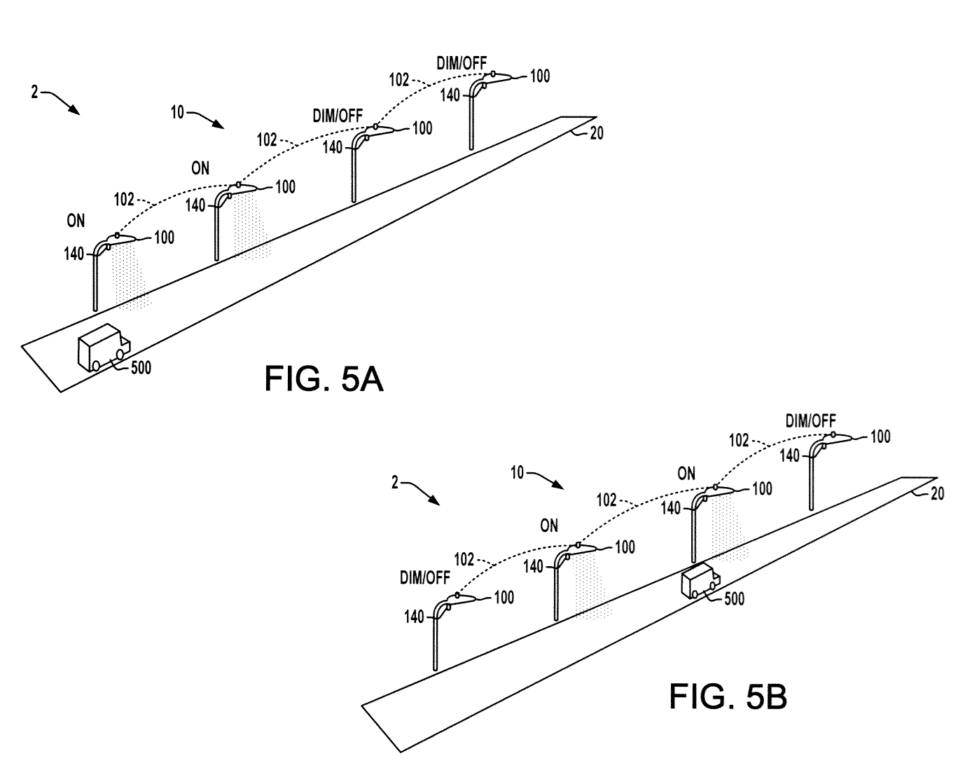

In the example of FIGS. 5A and 5B, moreover, the outdoor lighting fixtures 100 notify one another of a sensed occupancy or motion signal or message received from the sensor 140 via the RF mesh network 10. This facilitates a remotely controlled fixture 100 to bring the luminaire to full brightness despite a current diming setting, which may be particularly advantageous in security and safety critical applications in that it does not depend in any way on the health or current connectivity of the control system 202. For example, a sensor 140 associated with a given fixture 100 (or associated with a portion of a roadway 20 proximate a given fixture 100) can alert the fixture that a vehicle is approaching during a period of time with low expected traffic in which a dimming control scheme or profile is currently used. The notified fixture 100 can alert other fixtures 100 along the roadway for controlled overriding of the dimming control (e.g., to briefly turn their light outputs up to full lighting) while the associated portions of the roadway are occupied. As shown in the example of FIG. 5A, when a vehicle 500 approaches (and is sensed by) a first of four fixtures 100, the first fixture goes from off/dimming operation to an ON condition and notifies the next fixture 100 to do the same, while subsequent fixtures 100 remain in the off/dimmed condition. As the vehicle 500 continues down the roadway 20, signaling from a subsequent sensor 140 is relayed/reported through the mesh network 10 to cause a third fixture 100 to turn ON, while the first fixture 100 returns to the dimmed/off operation. This system thus facilitates the conservation of electric power while providing timely lighting as needed by intelligent usage of the sensors 140 and sharing of the sensed condition information within the network 10. Moreover, the sensed condition(s) can be relayed to the lighting control system 202 in certain embodiments, where the lighting control system 202 can be interconnected with security systems and relay sensed occupancy/motion conditions for appropriate responsive or remedial action.

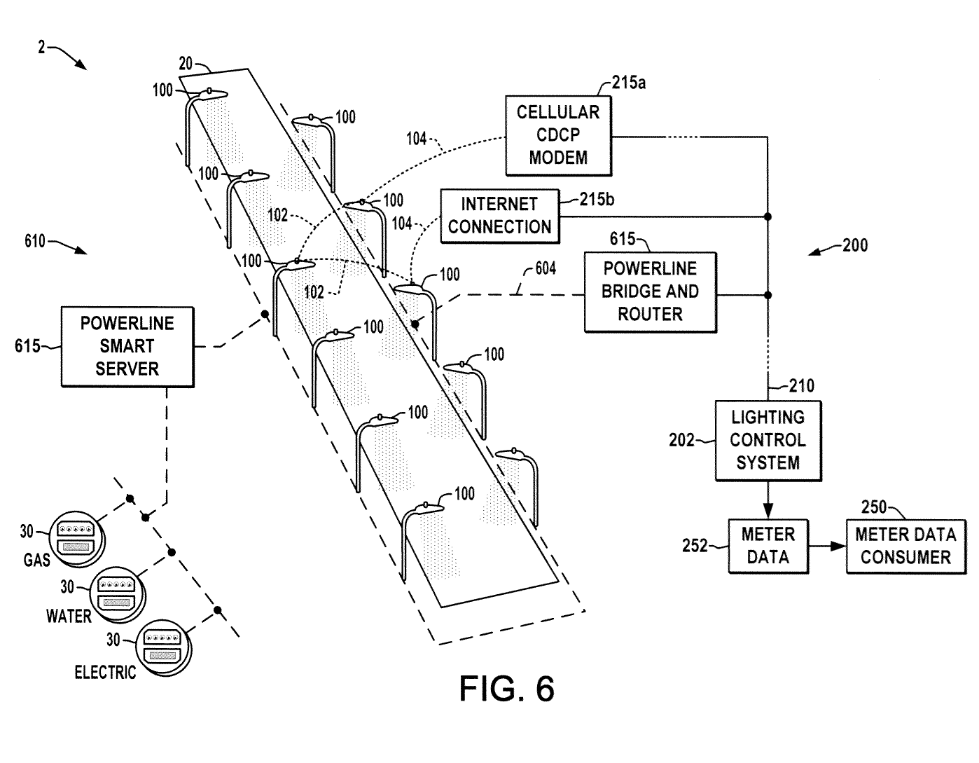

Referring also to FIG. 6, the outdoor lighting system 2 may also or alternatively include Power Line Communication (PLC)-enabled outdoor lighting fixtures 100 forming a Lighting system network 610 that is bridged with the lighting control system 202 of the general purpose network system 200. In this example, the lighting control system 202 obtains data from PLC-enabled utility meters 30 by communications through the general purpose network 210 and the lighting system network 610. The PLC-enabled outdoor lighting fixtures 100 are operative to communicate by power line signaling with at least one PLC-enabled utility meter 30 via the PLC outdoor lighting network 610, with one or more bridging components 215 and/or a powerline bridge and router 615 providing communications interfacing between the lighting network 610 and the general purpose network 210. The lighting control system 202 operates as described above to control or monitor one or more of the PLC-enabled fixtures 100 and also obtains meter data 252 from the PLC-enabled utility meter(s) 30 by communications through the general purpose network 210, the bridging component 215, 615, and the PLC outdoor lighting network 610. The outdoor lighting network 610 in certain embodiments includes at least one RF communications connections 102 between at least two of the outdoor lighting fixtures 100 as described above, and the RF-based and PLC-based operations can be used separately or in combination in various embodiments.

In certain embodiments, a modem bridging component 215a is coupled with one or more PLC-enabled outdoor lighting fixture 100 to provide communications interfacing between the lighting network 610 and the general purpose network 210. In certain embodiments, an Internet bridging component 215b provides an Internet connection to the PLC-enabled fixture 100 to interface communications between the PLC network 610 and the general purpose network 210. In certain embodiments, the bridging component is a powerline bridge and router 615 that provides communications interfacing between the PLC outdoor lighting network 610 and the general purpose network 210. Multiple bridging components can be used in the various implementations, along with repeaters 400 (e.g., FIG. 4 above) to connect segments of a PLC/RF network 610, 10. Moreover, the PLC-enabled devices 100, 140, 615, etc. may provide multiple protocol support, for instance, with one protocol used for communicating with fixtures 100 and another used for communicating with utility meters 30. Moreover, the above described occupancy sensor functionality and usage can be employed via one or more occupancy or motion sensors 140 (e.g., RF, directly connected, and/or PLC-enabled) which are operatively coupled with one of the PLC-enabled outdoor lighting fixtures 100. The lighting fixture 100, moreover, is operative to notify another fixture 100 of a sensed occupancy or motion signal or message received from the sensor 140 via the PLC outdoor lighting network 610.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been illustrated and/or described with respect to only one of several implementations, such feature may be combined with one or more other features of the other implementations as may he desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”. The invention has been described with reference to the preferred embodiments. Modifications and alterations will occur to others upon reading and understanding the preceding detailed description. It is intended that the invention be construed as including all such modifications and alterations.

The following is claimed:

1. An outdoor lighting system, comprising:
at least one Power-Line-Communication (PLC)-enabled outdoor lighting fixture operative to communicate by power line signaling with at least one PLC-enabled utility meter via a PLC outdoor lighting network;
a bridging component providing communications interfacing between the PLC outdoor lighting network and a general purpose network;
a lighting control system operatively coupled with the general purpose network to control or monitor at least one of the PLC-enabled outdoor lighting fixtures and to obtain data from the at least one PLC-enabled utility meter via communications through the general purpose network, the bridging component, and the PLC outdoor lighting network.

2. The outdoor lighting system of claim 1, where the bridging component is a modem coupled with the at least one PLC-enabled outdoor lighting fixture to provide communications interfacing between the PLC outdoor lighting network and the general purpose network.

3. The outdoor lighting system of claim 2, where the PLC-enabled outdoor lighting fixture establishes PLC network connections to form a first PLC outdoor lighting network and other PLC-enabled outdoor lighting fixtures establishes PLC network connections to form a second PLC outdoor lighting network, further comprising a repeater providing communications interfacing between the first and second PLC outdoor lighting networks.

4. The outdoor lighting system of claim 2, further comprising at least one occupancy or motion sensor operatively coupled with one of the PLC-enabled outdoor lighting fixtures, where the one of the PLC-enabled outdoor lighting fixtures notifies another one of the PLC-enabled outdoor lighting fixtures of a sensed occupancy or motion signal or message received from the at least one occupancy or motion sensor via the PLC outdoor lighting network.

5. The outdoor lighting system of claim 1, where the bridging component provides an Internet connection to the at least one PLC-enabled outdoor lighting fixture to provide communications interfacing between the PLC outdoor lighting network and the general purpose network.

6. The outdoor lighting system of claim 5, where the PLC-enabled outdoor lighting fixture establishes PLC network connections to form a first PLC outdoor lighting network and other PLC-enabled outdoor lighting fixtures establishes PLC network connections to form a second PLC outdoor lighting network, further comprising a repeater providing communications interfacing between the first and second PLC outdoor lighting networks.

7. The outdoor lighting system of claim 5, further comprising at least one occupancy or motion sensor operatively coupled with one of the PLC-enabled outdoor lighting fixtures, where the one of the PLC-enabled outdoor lighting fixtures notifies another one of the PLC-enabled outdoor lighting fixtures of a sensed occupancy or motion signal or message received from the at least one occupancy or motion sensor via the PLC outdoor lighting network.

8. The outdoor lighting system of claim 1, where the bridging component is a powerline bridge and router operative to provide communications interfacing between the PLC outdoor lighting network and the general purpose network.

9. The outdoor lighting system of claim 8, where the PLC-enabled outdoor lighting fixture establishes PLC network connections to form a first PLC outdoor lighting network and other PLC-enabled outdoor lighting fixtures establishes PLC network connections to form a second PLC outdoor lighting network, further comprising a repeater providing communications interfacing between the first and second PLC outdoor lighting networks.

10. The outdoor lighting system of claim 8, further comprising at least one occupancy or motion sensor operatively coupled with one of the PLC-enabled outdoor lighting fixtures, where the one of the PLC-enabled outdoor lighting fixtures notifies another one of the PLC-enabled outdoor lighting fixtures of a sensed occupancy or motion signal or message received from the at least one occupancy or motion sensor via the PLC outdoor lighting network.

11. The outdoor lighting system of claim 1, where the PLC outdoor lighting network includes at least one RF communications connection between at least two of the outdoor lighting fixtures.

12. A method for operating an outdoor lighting system, the method comprising:
establishing Power-Line-Communication (PLC) network connections between a plurality of PLC-enabled outdoor lighting fixtures to form a PLC outdoor lighting network;
establishing at least one auxiliary communications connection between at least one of the PLC-enabled outdoor lighting fixtures of the PLC outdoor lighting network and at least one PLC-enabled utility meter;
providing communications interfacing between the PLC outdoor lighting network and a general purpose network;
using a processing element, controlling or monitoring at least one of the PLC-enabled outdoor lighting fixtures via communications through the general purpose network and the PLC outdoor lighting network; and
using the processing element, obtaining data from the at least one PLC-enabled utility meter via communications through the general purpose network and the PLC outdoor lighting network.

13. The method of claim 12, further comprising establishing RF connections between at least some of a plurality of the PLC-enabled outdoor lighting fixtures of the PLC outdoor lighting network.

14. The method of claim 13, further comprising:
operatively coupling at least one occupancy or motion sensor with one of the PLC-enabled outdoor lighting fixtures; and
notifying another one of the PLC-enabled outdoor lighting fixtures of a sensed occupancy or motion signal or message received from the at least one occupancy or motion sensor via the PLC outdoor lighting network.

15. The method of claim 12, further comprising:
operatively coupling at least one occupancy or motion sensor with one of the PLC-enabled outdoor lighting fixtures; and
notifying another one of the PLC-enabled outdoor lighting fixtures of a sensed occupancy or motion signal or message received from the at least one occupancy or motion sensor via the PLC outdoor lighting network.

16. An outdoor lighting fixture apparatus, comprising:
a fixture assembly comprising:
a fixture housing,
at least one light source supported in the fixture housing, and
at least one ballast or driver supported in the fixture housing and electrically coupled to provide power to the light source; and
a controller module, comprising a Power-Line-Communication (PLC) transceiver operative to provide powerline communications using a first communications protocol with at least one other outdoor lighting fixture apparatus in a PLC outdoor lighting network, the PLC transceiver operative to provide powerline communications using a second communications protocol with at least one PLC-enabled utility meter.

17. The outdoor lighting fixture apparatus of claim 16, where the controller module comprises an RF transceiver operative to provide RF communications with another outdoor lighting fixtures of the PLC outdoor lighting network.

18. The outdoor lighting fixture apparatus of claim 17, comprising at least one occupancy or motion sensor operatively coupled with the controller module.

19. The outdoor lighting fixture apparatus of claim 16, comprising at least one occupancy or motion sensor operatively coupled with the controller module.

20. The outdoor lighting fixture apparatus of claim 19, where the controller module is operative to notifying another outdoor lighting fixture apparatus of a sensed occupancy or motion signal or message received from the at least one occupancy or motion sensor via the outdoor lighting network.
